(19) United States
(12) Patent Application Publication
(10) Pub. No.: US 2026/0192489 A1
(43) Pub. Date: Jul. 9, 2026

(54) L-SHAPED FORM AND SYSTEM FOR MANUFACTURING PRECAST WALLS

(71) Applicant: B2B EMPREENDIMENTOS IMOBILIARIOS LTDA., Três Rios (BR)

(72) Inventor: Felippe Bastos de Lima, Rio de Janeiro (BR)

(73) Assignee: B2B EMPREENDIMENTOS IMOBILIARIOS LTDA., Três Rios (BR)

(21) Appl. No.: 19/442,290

(22) Filed: Jan. 7, 2026

(30) Foreign Application Priority Data
Jan. 8, 2025 (BR) 102025000333 3
Dec. 31, 2025 (BR) 102025029543 1

(51) Int. Cl. B28B 7/24; B28B 1/14; B28B 7/22

(52) U.S. Cl. CPC B28B 7/248; B28B 1/14; B28B 7/22

(57) ABSTRACT

The present invention relates to a form for manufacturing precast walls comprising: at least two L-shaped structures arranged apart and parallel to each other, forming a space for pouring concrete, said structures being held together by pressing devices; wherein each L-shaped structure comprises two plates connected perpendicularly; at least one horizontal profile disposed in a bottom of the form and between said L-shaped structures; at least two vertical beams supported on said horizontal profile and closing the sides of said form.

### INCORPORATION BY REFERENCE TO ANY PRIORITY APPLICATIONS

Any and all applications for which a foreign or domestic priority claim is identified, for example, in the Application Data Sheet or Request as filed with the present application, are hereby incorporated by reference under 37 CFR 1.57, and Rules 4.18 and 20.6, including BR Provisional Application Nos. BR 102025000333 3, filed Jan. 8, 2025, and BR 102025029543 1, filed Dec. 31, 2025.

### FIELD OF THE INVENTION

The present invention relates to an L-shaped form (or mold) used for manufacturing precast concrete walls in a vertical position in the construction industry and a system comprising a form and a rail for moving and handling the form.

### BACKGROUND OF THE INVENTION

The manufacture of precast concrete walls is a widely used technique in the construction industry, offering advantages in terms of efficiency, quality, and sustainability. Several approaches and technologies are employed to manufacture and assemble precast concrete walls.

For the implementation of the precast wall manufacturing method, are used manufacturing forms. The manufacturing forms are fundamental for shaping the concrete and giving form to precast walls. These forms can be made of wood, steel, fiberglass reinforced plastic (FRP), or similar materials, and are designed to create walls with different finishes and structural characteristics.

However, existing precast wall formwork systems generally require assembly braces and the need for squaring and plumbing steps to ensure that the walls are constructed correctly, with the exact angles.

Furthermore, in the manufacture of precast walls, the existence of windows and doors in the design creates a complication, since such elements require the formation of openings that are difficult to execute in a precast construction.

In known state-of-the-art solutions, the manufacture of precast walls usually occurs from substantially flat forms, into which concrete is poured and compacted to obtain an essentially rectilinear element. In these arrangements, the wall is produced as a predominantly linear piece. In practice, this means that, after demolding, the element obtained from the flat form depends on temporary supports, bracing, and tying procedures to remain in a stable position until its final installation.

A recurring scenario on construction sites illustrates the limitations of these solutions: when releasing a wall produced in a flat form and temporarily positioning it for storage or for preparation for lifting, small variations in support on the ground, leveling imperfections, or unintentional displacements can induce progressive tilting of the element. The need to reposition the part and adjust supports often involves operators approaching the potential fall line. In this situation, any loss of stability, even momentary, can create a risk of the structure tipping over onto the team of employees, generating a serious accident scenario and requiring additional safety and logistical measures to mitigate the risk.

Thus, there is a constant search for technical solutions that promote the optimization of the formwork system characteristics for the construction of precast concrete walls.

### OBJECTIVES OF THE INVENTION

One of the objectives of the invention is to provide a form that can be easily assembled and disassembled, allowing for mobility to different locations.

Another objective of the invention is to provide manual operation of the formwork locks and the shaping of windows and walls, significantly reducing acquisition costs.

Another objective of the invention is to provide a safe working environment for handling the form.

Another objective of the invention is to provide simple wall modeling, enabling the adaptation of wall sizes and allowing the construction of walls of different dimensions for any architectural project.

Another objective of the present invention is to provide pressing devices that ensure the stability of the forms during filling with concrete.

Another objective of the present invention is to provide a way to produce several walls simultaneously, both in L-shape and in rectangular or square shape, already in the vertical position.

### BRIEF DESCRIPTION OF THE INVENTION

The present invention relates to a form for manufacturing precast walls comprising: at least two L-shaped structures arranged spaced apart and parallel to each other, forming a space for pouring concrete, said structures being held together by pressing devices; wherein each L-shaped structure comprises two plates connected perpendicularly; at least one horizontal profile disposed at the bottom of the form and between said L-shaped structures; at least two vertical beams supported on said horizontal profile and closing the sides of said form.

In one embodiment of the present invention, each vertical beam is held in position by means of a locking mechanism disposed at both ends of said vertical beam.

In one embodiment of the present invention, the locking mechanism comprises a movable angle bracket having an elongated opening in which a screw is received, the movable angle bracket being movable by the movement of the elongated opening relative to the screw.

In one embodiment of the present invention, the locking mechanism comprises at least one movable screw that passes through the vertical beam and rests against at least one support profile, the at least one support profile being movable on an edge of the form.

In one embodiment of the present invention, each of said L-shaped structures comprises upper, lower and side edges, and the pressing device comprises tubes fixed to the upper, lower and side edges of each of said outermost L-shaped structures, wherein a threaded bar is inserted into each said pair of tubes, and wherein nuts act on said threaded bar pressing said L-shaped structures together.

In one embodiment of the present invention, said pressing device is arranged on the upper, lower and lateral edges of each of said L-shaped structures.

In one embodiment of the present invention, the form is movable and comprises wheels arranged on the lower edge of the plates, wherein said wheels act on rails.

In one embodiment of the present invention, each plate comprises at least one lifting support disposed on its upper edge.

In one embodiment of the present invention, said outer L-shaped structures have structural reinforcements on their outer faces.

In one embodiment of the present invention, said vertical beams have holes for the passage of connecting bars between the walls.

In one embodiment of the present invention, the horizontal profile comprises two horizontal beams, of equal thickness to said vertical beams, each welded to a respective plate of said two plates.

In one embodiment of the present invention, said horizontal beams are identical to said vertical beams.

In one embodiment of the present invention, the form further comprises at least one modeling frame, fixed to the form by means of at least one fastener, for making window and door openings.

In one embodiment of the present invention, the fastener (25) is at least one of the following: a magnetic fastener, a spot weld fastener or a screw fastener.

The present invention also relates to a system for manufacturing precast walls characterized in that it comprises: at least one rail; at least one lifting element; a platform; and at least one form configured to slide on the at least one rail.

In one embodiment of the present invention, the lifting element has an L-shaped profile, with beams interlaced between the two legs of the L, and hooks arranged along its L-shaped profile.

In one embodiment of the present invention, the platform is arranged on the outermost face of the form and has a guardrail and access ladder.

In one embodiment of the present invention, the form is slid along the rails by actuation of at least one motor.

### BRIEF DESCRIPTION OF THE DRAWINGS

The present invention will be described in more detail below, with reference to the accompanying drawings, in which:

FIG. 1—is a top perspective view of a form according to the present invention.

FIG. 2—is a detailed view of the pressing device according to the present invention.

FIG. 3—is a bottom perspective view of a form according to the present invention.

FIG. 4—is a front perspective view of the plate according to an embodiment of the present invention.

FIG. 5—is an illustrative front view of the mesh as placed within the form according to the present invention.

FIG. 6—is a front perspective view of the inner face of the L-shaped structure;

FIGS. 7A and 7B—are a detailed view of the movable angle bracket according to an embodiment of the present invention;

FIGS. 8A and 8B—are a detailed view of the lock with movable screws according to an embodiment of the present invention;

FIG. 9—is an illustrative front perspective view of the magnetic locking according to an embodiment of the present invention;

FIG. 10—is an illustrative front perspective view of the inner face of the L-shaped structure with the magnetic fasteners;

FIG. 11—is a side perspective view of the system according to an embodiment of the present invention;

FIG. 12—is a side view of the system according to an embodiment of the present invention;

FIG. 13—is a rear perspective view of the system according to an embodiment of the present invention.

### DETAILED DESCRIPTION OF THE INVENTION

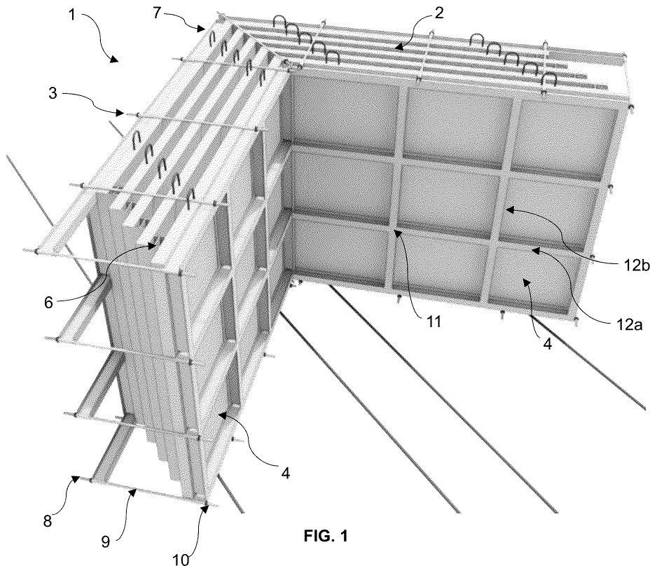

FIG. 1 illustrates, according to one embodiment of the present invention, a perspective view of form 1 comprising L-shaped structures 2, preferably made of a mixture of steel and concrete, arranged spaced apart and parallel to each other, forming a space for pouring concrete. The said L-shaped structures 2 being held together by pressing devices 3 and comprising two plates 4 connected perpendicularly to form the L shape. The connection between the plates 4 is made by means of anchor bolts.

In other embodiments of the present invention, the L-shaped structures 2 may be made of steel only, concrete only, or any other material that provides sufficient rigidity for concreting in form 1.

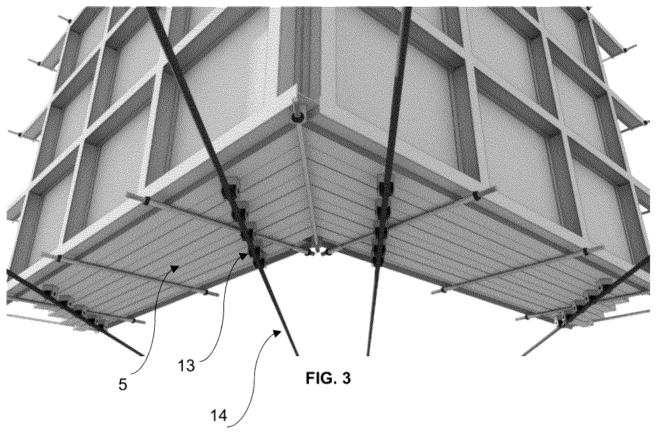

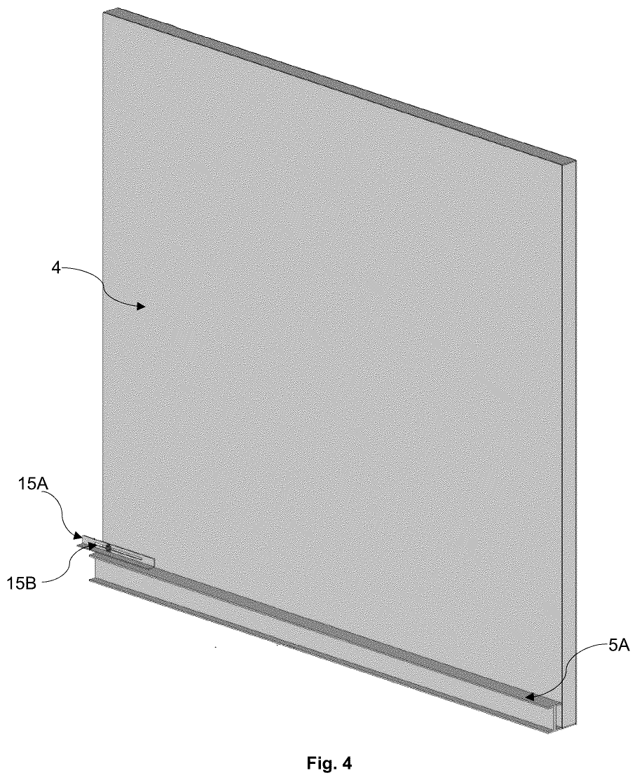

Between said L-shaped structures 2 are arranged a horizontal profile 5 (illustrated in FIGS. 3 and 4), welded together with structures 2, and two vertical beams 6. Said horizontal profile 5 is located at the bottom of the form and said vertical beams 6 are supported on said horizontal profile 5 to close the sides of the form 1. The aforementioned vertical beams 6 also have holes (not shown), usually four or five, for the passage of connecting bars between the walls. The bottom of form 1 should be understood as its lowest region.

The horizontal displacement of the vertical beams 6 allows for the modeling of the wall length. For this, the vertical beams 6 can be moved to various positions on top of the horizontal profile 5, obtaining various wall lengths and allowing the production of walls in L-shape as well as rectangular or square shapes.

The vertical beams 6 are fixed to the L-shaped structures 2 by a locking mechanism (illustrated in FIG. 4) comprising a movable angle bracket 15A, bolted to the structure 2 and positioned above the horizontal profile 5, in order to prevent the vertical beams 6 from shifting during the concreting process. The aforementioned angle bracket 15A has an elongated opening 15B that allows it to be moved.

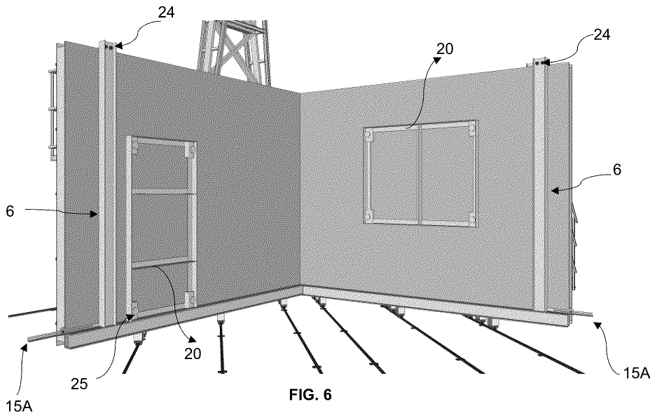

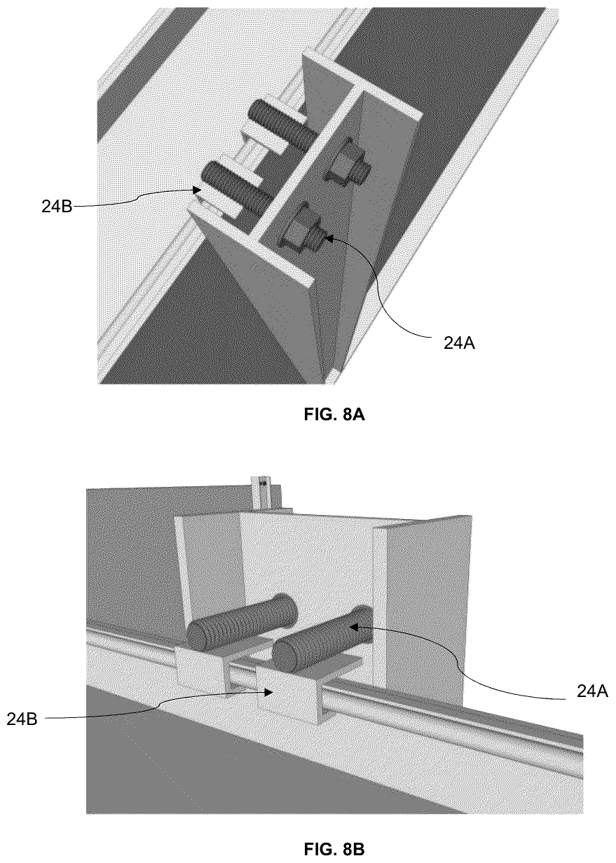

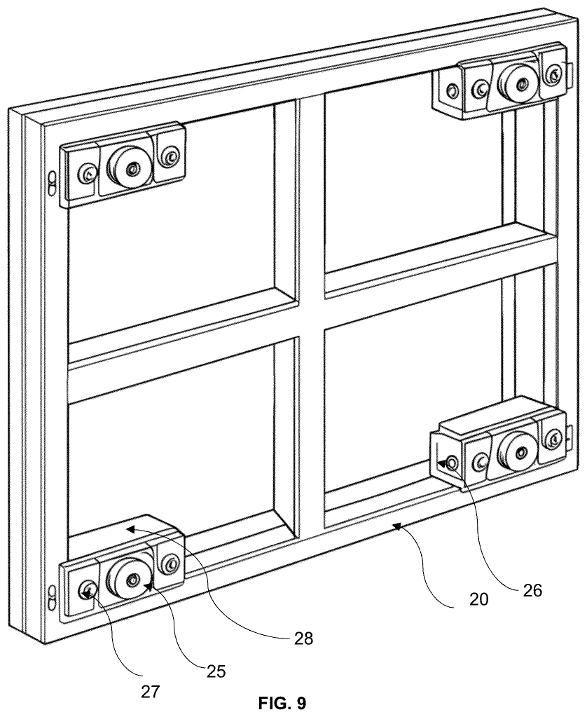

In other embodiments of the present invention, the locking mechanism is arranged at both ends of each vertical beam 6, as will be described in FIG. 6, allowing locking at both the upper and lower ends and thus reinforcing the locking during concreting. The locking mechanism can also be a lock with movable screws, as illustrated in FIGS. 8A and 8B, or a magnetic lock, as illustrated in FIG. 9.

In addition to modeling the wall length, it is possible to model its height and thickness. The height is modeled by calculating the amount of concrete that will be poured into form 1. The wall thickness is obtained by the width of the vertical beams 6 and the horizontal profile 5 that close the outline of the form.

FIG. 1 further illustrates said form 1 comprising lifting supports 7 arranged on said structures 2 for the purpose of lifting form 1. Said lifting supports 7 having the shape of an eyelet to facilitate their handling by means of a gantry, crane or similar, with two eyelets 7 positioned on the upper edge of each of said plates 4.

Other embodiments of the present invention may have other types of lifting support 7 and in quantities different from that illustrated in FIG. 1. In this sense, it is possible that there may be one or more lifting supports according to the present invention.

FIG. 1 further illustrates the outermost L-shaped structures 2 comprising, around their lower, upper and lateral edges, the aforementioned pressing devices 3 responsible for pressing and fixing the form 1 during concreting. The pressing devices 3, according to the embodiment shown in FIG. 1, comprise tubes 8 fixed to the edges of each of the outermost L-shaped structures 2, in which a threaded bar 9 is inserted into each pair of tubes 8, and in which nuts 10 act on the threaded bar 9 pressing said L-shaped structures 2 together. The pressing devices 3 are preferably arranged around form 1 in the following manner: six upper pressing devices, six lower pressing devices, four left pressing devices and four right pressing devices.

Other embodiments of the present invention may have different quantities of pressing devices 3 and in different positions from those shown in FIG. 1. Furthermore, other models may also have the pressing devices 3 arranged in each of the L-shaped structures 2, not just in the outermost structures.

FIG. 1 further illustrates the external faces of form 1 comprising structural reinforcements 11 which preferably comprise two horizontal support beams 12a and two vertical support beams 12b. These support beams 12a, 12b are intended to reinforce form 1, resisting the forces during concreting and preventing form 1 from warping.

Other embodiments of the present invention may have different quantities of support beams 12a, 12b in the horizontal, vertical or other directions than those shown in FIG. 1.

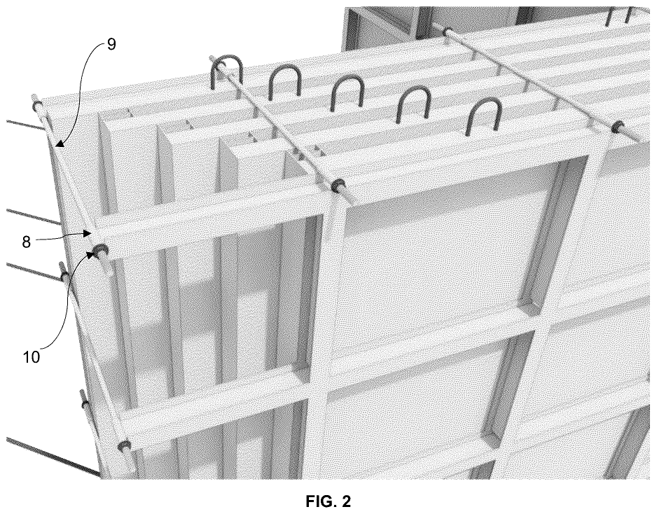

FIG. 2 illustrates in more detail the high-strength steel threaded bars 9 inserted into each pair of tubes 8 and pressed by the nuts 10, ensuring the stability and pressing of the forms 1 during filling with concrete and the ease of assembling and disassembling them.

FIG. 3 illustrates wheels 13 arranged on the lower edges of each of said L-shaped structures 2. Each structure 2 preferably has four wheels 13 that are connected to rails 14 arranged on the ground, forming a system to facilitate the movement of the structures 2, so that the shape 1 can be easily moved for its assembly and disassembly.

Other embodiments of the present invention may have different numbers of wheels in different positions than those shown in FIG. 1.

FIG. 3 further illustrates said horizontal profiles 5 arranged between the L-shaped structures 2 at the bottom of form 1. The horizontal profiles 5 comprise two horizontal beams 5A, connected/abutting perpendicularly, closing the bottom of form 1.

As illustrated in FIG. 4, each plate 4 has a horizontal beam 5A, identical to the vertical beam 6 or only of the same thickness, welded to it, so that between two L-shaped structures 2 there is only one horizontal profile 5.

In other embodiments of the present invention, the horizontal profiles 5 can be welded in such a way that between two L-shaped structures 2 there are two or more horizontal profiles 5, making it possible to construct walls of different thicknesses.

In other embodiments of the present invention, said profile 5 may be a continuous L-shaped profile welded together with the plates 4 of the L-shaped structure.

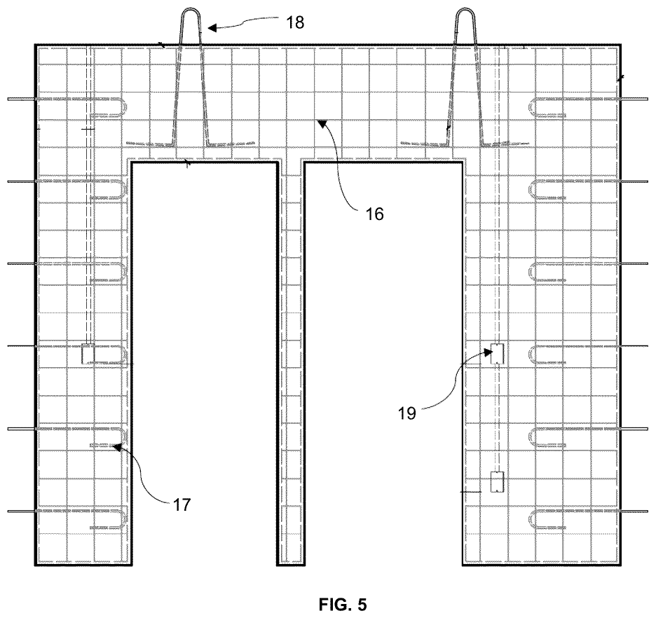

FIG. 5 illustrates an exemplary embodiment of the internal structure of the wall.

When form 1 is assembled as illustrated in FIG. 1, before concreting, a steel mesh 16 is inserted to reinforce the wall. Attached to this mesh 16 are umbrella handle-shaped bars 17, lifting bars 18 and the electrical installations 19. After the concrete is poured, an extension of the umbrella bars 17 protrudes from the side of the wall, allowing it to be joined to other walls by welding, just as a length of the lifting bars 18 protrudes from the upper edge to lift the wall. After the concreting step, an extension of the umbrella-type bars 17 protrudes from the side of the wall, allowing it to be joined to other walls by welding, just as a length of the lifting bars 18 protrudes from the upper edge to lift the wall.

FIG. 6 illustrates an exemplary embodiment for the manufacture of window and door openings, in which modeling frames 20 are fixed in forms 1. The fixing of the modeling frames 20 is done by fasteners 25.

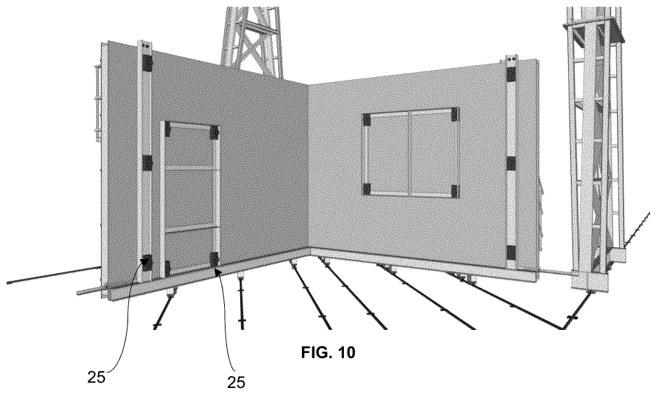

The use of the 20 modeling frames with 25 fasteners ensures the creation of window and door openings of different sizes, in a quick and simplified way. The fasteners 25 allow the modeling frames to be easily attached to the L-shaped structure 2. An illustrative embodiment of the fasteners will be described below with reference to FIGS. 9 and 10.

FIG. 6 further illustrates the locking mechanism located at both ends of each vertical beam 6. In the exemplary embodiment of FIG. 6, the vertical beams 6 are locked, at the lower end, it is secured by a movable angle bracket 15A and, at the upper end, by a locking mechanism 24 with movable screws 24A, allowing locking at both the upper and lower ends, thus reinforcing the locking during concreting.

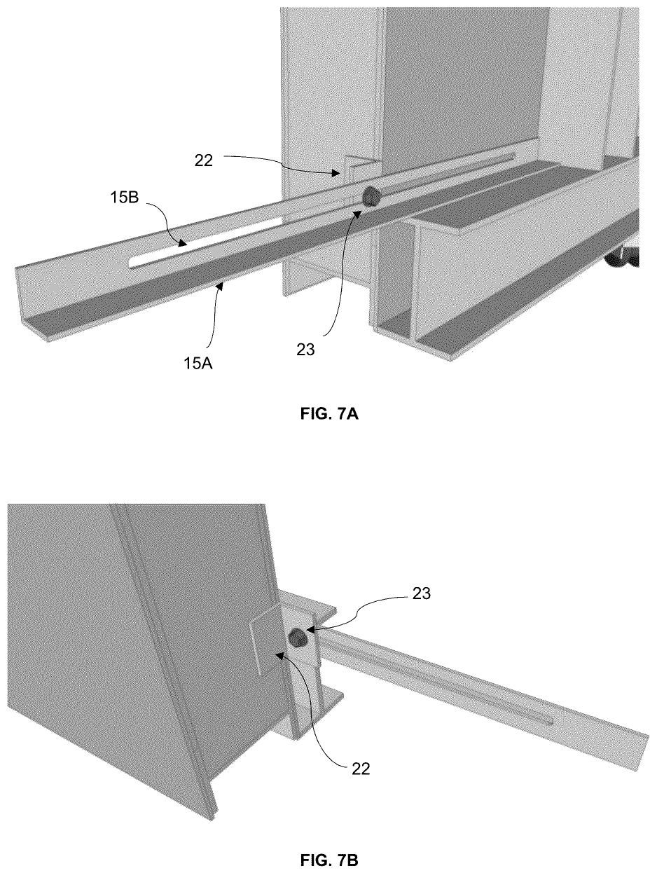

FIGS. 7A and 7B illustrate the movable angle bracket 15A used in the exemplary embodiment of FIG. 6. The movable angle bracket 15A has an elongated opening 15B through which a screw 23 is moved to adjust the position of the vertical beam 6. The angle bracket 15A is fixed by means of a support element 22 welded to form 1. The support element 22 has a hole for the passage of the screw 23 which is moved along the elongated opening 15B of the movable angle bracket 15A, ensuring a quick and secure adjustment of the vertical beam 6.

FIGS. 8A and 8B illustrate the lock 24 with movable screws 24A used in the exemplary embodiment of FIG. 6. In this embodiment, the lock 24 comprises two movable screws 24A that pass through the vertical beam 6 and rest against two support profiles 24B. The 24B support profiles are movable along the upper edge of the form, allowing the vertical beam 6 to be fixed in different locations.

In this embodiment, the vertical beams 6 have two upper holes for passing 24A screws. This allows the vertical beam 6 to be moved and fixed in any position of form 1, making walls of different dimensions even safer during concreting.

FIG. 9 illustrates an exemplary embodiment of the fasteners 25 for removable attachment of the modeling frames 20 to metal forms. In this embodiment, the fasteners are magnetic fasteners 25 positioned, preferably, in lugs 26 welded peripherally to the modeling frame 20, such as at its corners. The lugs 26 have at least one opening for the passage of screws 27 that attach the magnetic fasteners 25 to the modeling frame 20. The magnetic fasteners 21 comprise a housing 28, fixed by means of said screws 27 to said lugs 26 of the modeling frame 20, and at least one magnetic element housed in the housing 28, the magnetic element being configured to be actuated by an actuator to generate a magnetic field capable of attracting a ferromagnetic surface of form 1. The actuator is preferably a button or lever.

Thus, when the operator brings the modeling frame 20 close to the mold 1, the activated magnetic element exerts an attractive force that pulls and holds the modeling frame against the mold 1, promoting temporary locking/anchoring in the desired position.

The magnetic fastening provided by the magnetic fastener 25 allows the modeling frame 20 to remain stable during assembly steps and during concrete pouring/vibration, reducing unwanted displacements. Finally, to remove the modeling frame 20, the operator simply needs to release the magnetic fastener 25.

Optionally, each magnetic fastener 25 can be sized and configured to allow positioning adjustment in relation to the modeling frame 20, for example by means of more than one fastening region/lug 26, in order to adapt the position of the housing 28 to the geometry of the form 1 and/or the thickness of the wall to be concreted.

Optionally, the magnetic element can be implemented as a magnetic core, permanent magnet, set of permanent magnets or equivalent magnetic arrangement, with circular, cylindrical and/or annular geometry, and the housing 28 can house one or more magnetic elements.

In any of these embodiments, the technical effect sought is to obtain a quick, repeatable and removable fixation of the modeling frame 20 on a metallic surface of form 1, without the need for drilling, screws, welding or complex clamping systems in form 1.

In other embodiments of the present invention, the modeling frame 20 can be attached to the mold 1 by means of mechanical fasteners, replacing the magnetic fastener 25 described above.

In a first variation, the mechanical fastener is configured to allow fastening by spot welding. In this configuration, the modeling frame 20 may include, in its peripheral regions, one or more welding tabs/ears and/or contact surfaces for welding, dimensioned to abut the mold 1. Thus, after positioning the modeling frame in the desired location, the operator performs one or more welding points between the welding tab(s) and form 1, allowing for the temporary immobilization of the modeling frame 20 during the pouring and curing of the concrete. At the end, removal can be carried out by controlled rupture of the weld points (e.g., by cutting, grinding and/or controlled impact), allowing the removal and eventual reuse of the 20 modeling frame.

In a second variation, the mechanical fastener is configured for screw fastening. In this configuration, the modeling frame 20 may include one or more fastening supports, provided with through holes and/or slots, in order to receive threaded fastening elements, such as screws, studs and/or nuts. The form 1, in turn, may include threaded holes, welded nuts, threaded inserts, or other equivalent means of receiving the threaded element. Thus, the modeling frame 20 is positioned in form 1 and fixed by tightening the threaded elements, with the slots allowing for fine position adjustment before final tightening.

In both variations described (welding and/or screws), the technical effect obtained is the stable fixing of the modeling frame 20 to the form 1 during the concreting steps, and it can be subsequently removed, the choice between magnetic and mechanical fasteners depending on project requirements, infrastructure availability, formwork material, and the desired level of reuse and speed of assembly.

FIG. 10 illustrates an exemplary embodiment of the present invention in which magnetic fasteners 25 are employed to attach both the modeling frames 20 and the vertical beams 6 to form 1, in order to expedite and facilitate the positioning of these components. In this embodiment, fixation is achieved predominantly through magnetic action, reducing or eliminating the need for additional mechanical couplings for retention during assembly and concreting. Due to this characteristic, this embodiment offers faster and simpler installation, although it typically involves a higher cost compared to embodiments that use conventional mechanical fasteners.

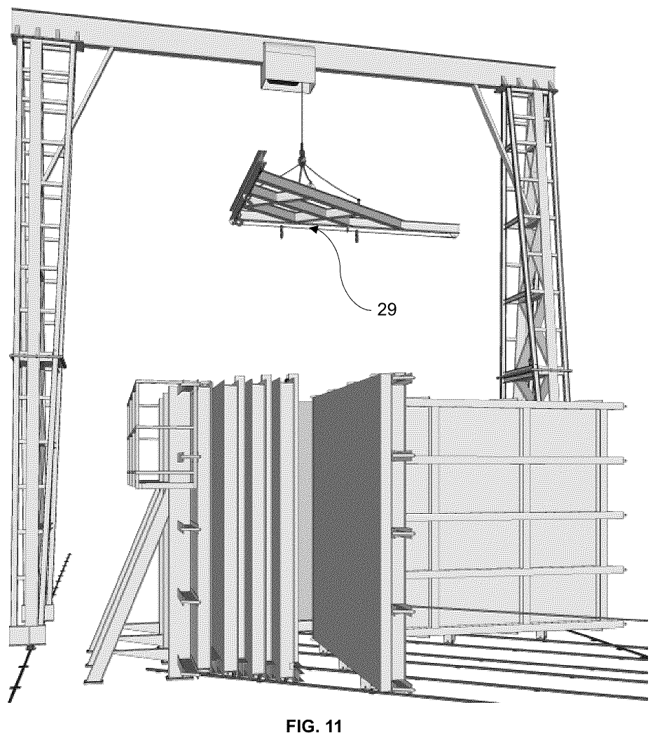

FIG. 11 illustrates an exemplary embodiment of the system according to the present invention, in which a lifting element 29 is used to lift the walls through a gantry. The lifting element 29 was developed specifically for L-shaped walls, which also have an L-profile with several beams interwoven between the two legs of the L to distribute the loads, preventing the wall from breaking when lifted. The lifting element 29 has hooks arranged along its L-shaped profile, which fit into the lifting bars 18 to lift the walls.

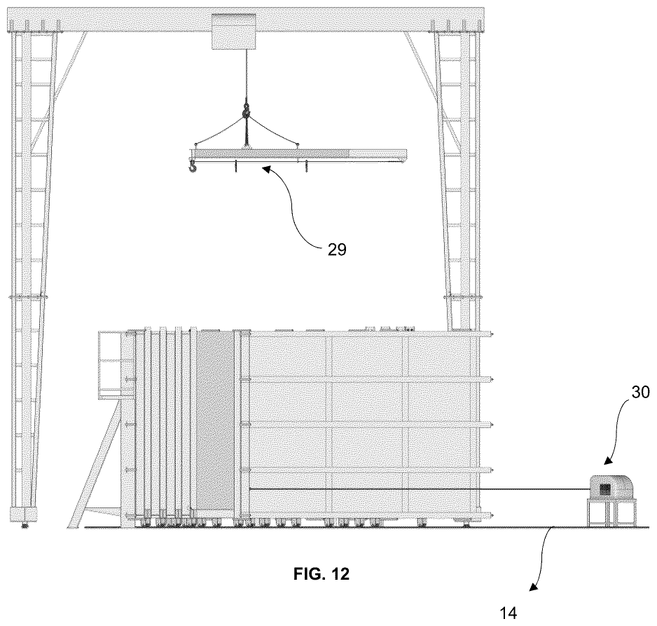

FIG. 12 illustrates an exemplary embodiment in which a motor 30 is used to move the L-shaped structures 2 of form 1 on the rails 14, facilitating their handling and speeding up the construction of the walls. Motor 30 is connected to the L-shaped structure 2 by means of at least one cable and, when activated, moves the L-shaped structures on the rails 14. In the illustrated embodiment, motor 30 is an electric motor.

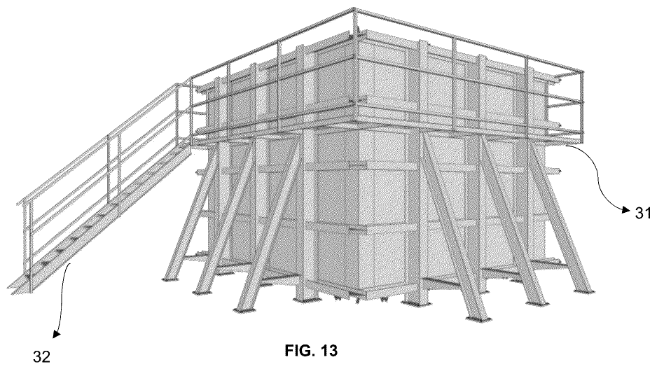

FIG. 13 illustrates the system of the present invention according to an exemplary embodiment, in which a platform with a guardrail 31 and an access ladder 32 is arranged on the outermost face of form 1, facilitating and making the operator's work safer. Platform 31 is welded to form 1 and supported by a base comprising several beams arranged along the outermost face of form 1.

In this way, due to its ease of assembly/disassembly and fully manual operation, form 1 of the present invention can be used in several projects on the same day, in addition to having a low acquisition cost. The form according to the present invention also makes it possible to produce walls of various dimensions and in L or rectangular/square shapes, in addition to the possibility of producing several walls simultaneously in a vertical position.

L-shaped walls also have the advantage of already being square for construction, eliminating 100% of the need for shoring, mitigating the risk of walls collapsing on operators, reducing the need for grouting and welding, and consequently increasing the speed of construction.

What is claimed is:

1. A form for manufacturing precast walls, characterized in that it comprises:
at least two L-shaped structures arranged apart and parallel to each other, forming a space for pouring concrete, the said structures being held pressed together by pressing devices; wherein each L-shaped structure comprises two plates connected perpendicularly;
at least one horizontal profile arranged in a bottom of the form and between said L-shaped structures;
at least two vertical beams supported on said horizontal profile and closing the sides of said form.

2. The form, according to claim 1, characterized in that each vertical beam is held in position by means of a locking mechanism disposed at both ends of said vertical beam.

3. The form, according to claim 2, characterized in that the locking mechanism comprises a movable angle bracket having an elongated opening in which it receives a screw, the movable angle bracket being movable by the movement of the elongated opening relative to the screw.

4. The form, according to claim 2, characterized in that the locking mechanism comprises at least one movable screw that passes through the vertical beam and rests against at least one support profile, the at least one support profile being movable on an edge of the form.

5. The form, according to claim 1, characterized in that each of said L-shaped structures comprises upper, lower and side edges, and the pressing device comprises tubes fixed to the upper, lower and side edges of each of said outermost L-shaped structures, wherein a threaded bar is inserted into each pair of tubes, and wherein nuts act on said threaded bar pressing said L-shaped structures together.

6. The form, according to claim 5, characterized in that said pressing device is disposed on the upper, lower and side edges of each of said L-shaped structures.

7. The form, according to claim 1, characterized in that it is movable and comprises wheels arranged on the lower edge of said plates, wherein said wheels act on rails.

8. The form, according to claim 1, characterized in that each plate comprises at least one lifting support disposed on its upper edge.

9. The form, according to claim 1, characterized in that said outermost L-shaped structures have structural reinforcements on their outer faces.

10. The form, according to claim 1, characterized in that said vertical beams have holes for the passage of connecting bars between the walls.

11. The form, according to claim 1, characterized in that said horizontal profile comprises two horizontal beams, of equal thickness to said vertical beams, each welded to a respective plate of said two plates.

12. The form, according to claim 11, characterized in that said horizontal beams are identical to said vertical beams.

13. The form, according to claim 1, characterized in that it comprises at least one modeling frame, fixed to the form by means of at least one fastener.

14. The form, according to claim 13, characterized in that the fastener is at least one of: a magnetic fastener, a spot weld fastener or a screw fastener.

15. A system for the manufacture of precast walls, characterized in that it comprises:
at least one rail;
at least one lifting element;
a platform; and
at least one form, as defined in claim 6, configured to slide on the at least one rail (14).

16. The system, according to claim 15, characterized in that the lifting element has an L-shaped profile, with beams interlaced between the two legs of the L, and hooks arranged along its L-shaped profile.

17. The system, according to claim 15, characterized in that the platform is disposed on the outermost face of the form and has a guardrail and access ladder.

18. The system, according to claim 15, characterized in that the form is slid on the rails by the actuation of at least one motor.
